(19) United States
(12) Patent Application Publication
(10) Pub. No.: US 2026/0306321 A1
(43) Pub. Date: Oct. 8, 2026

(54) DOOR AND VEHICLE HAVING THE SAME

(71) Applicants: Hyundai Motor Company, Seoul (KR); Kia Corporation, Seoul (KR); Kwangjin Co., Ltd., Asan-si (KR)

(72) Inventors: Dae Hun Song, Hwaseong-si (KR); Ki Hyun Choi, Hwaseong-si (KR); Hyo Seop Cha, Hwaseong-si (KR); Young Jun Kim, Hwaseong-si (KR); Hyuk Ho Kwon, Hwaseong-si (KR); Jun Yeong Bae, Asan-si (KR); Jin Su Jang, Asan-si (KR)

(21) Appl. No.: 19/258,033

(22) Filed: Jul. 2, 2025

(30) Foreign Application Priority Data
Apr. 2, 2025 (KR) 10-2025-0042700

(51) Int. Cl. A61G 3/06; B60J 5/04; B60J 5/06; B60K 1/04; B62D 25/02; B62D 25/20

(52) U.S. Cl. CPC A61G 3/067; A61G 3/061; B60J 5/0477; B60J 5/06; B62D 25/025; B62D 25/2036; B60K 2001/0438

(57) ABSTRACT

A vehicle can include a first side sill that includes a recess portion concaved downwardly, a second side sill spaced apart from the first side sill, a floor panel between and coupled to the first side sill and the second side sill, a battery positioned below the floor panel, a ramp apparatus located on the recess portion of the first side sill, and a door supported by a lower arm assembly coupled to the first side sill. The door can include a door panel, an upper arm assembly coupled to an upper portion of the door panel, including an upper slider, and configured to support the upper portion of the door panel, and the lower arm assembly coupled to a lower portion of the door panel and configured to support the lower portion of the door panel.

### CROSS-REFERENCE TO RELATED APPLICATIONS

This application claims benefit of priority to Korean Patent Application No. 10-2025-0042700 filed on Apr. 2, 2025 in the Korean Intellectual Property Office, the disclosure of which is incorporated herein by reference in its entirety.

### TECHNICAL FIELD

The present disclosure relates to a door and a vehicle having the same.

### BACKGROUND

For example, buses, or wheelchair-specific vehicles for disabled persons may include a ramp apparatus assisting in the boarding and disembarking of a disabled person in a wheelchair. The ramp apparatus is equipped with a platform that is stored in the vehicle body, and the platform is configured to be tilted at a certain incline with respect to the ground by being deployed from the vehicle body to the ground, manually by a user or automatically by a motor.

On the other hand, vehicles that use a motor as a driving source, such as hybrid vehicles or electric vehicles, use a high-voltage battery or the like as an energy source for driving the motor, and a battery module including multiple battery cells is mounted on the vehicle body at the bottom of the vehicle. In this case, if ramp apparatus for a wheelchair is mounted on the vehicle, the ramp apparatus interferes with the layout of the battery module because it is mainly mounted on the bottom of the vehicle, and cannot be applied.

To prevent this problem, if the ramp apparatus is disposed on the floor panel of the vehicle, the step height increases, making it inconvenient for passengers to enter and exit. In addition, because the height of the ramp apparatus from the ground is high, the inclination of the platform is difficult to satisfy the inclination of a regulation (for example, 7.1°), and there is a disadvantage that the step difference between the platform and the interior floor is excessive.

In addition, for example, if the door is a sliding door, the door rail and the ramp apparatus interfere due to space constraints, and thus the platform cannot be pulled out. Alternatively, if the door is a swing door, the length and shape of the door arm are limited, so that the door opening amount is insufficient. To resolve this, for example, to increase the opening amount, if the length and/or shape of the arm are made large, there is a problem that the arm interferes with the vehicle body.

### SUMMARY

The present disclosure relates to a door, which can operate in a complex manner without interference with a ramp apparatus for assisting boarding and disembarking of a wheelchair, and a vehicle having the same.

An embodiment of the present disclosure can provide a door that may be installed without interference with a layout of a battery module and an operation of a ramp apparatus, as well as a vehicle body, and a vehicle having the same.

An embodiment of the present disclosure can provide a vehicle equipped with a door in which an opening amount may be secured and thus the convenience for passengers entering or exiting may be maintained and/or improved, together with a ramp apparatus that allows the inclination of a platform to satisfy the inclination required by a regulation without increasing a step height.

According to an embodiment of the present disclosure, a vehicle can include: a floor panel coupled to a pair of side sills spaced apart from each other and having a recess portion concave downwardly; a battery module positioned below the floor panel; a ramp apparatus located on the recess portion; and a door supported by a lower arm assembly coupled to the side sills.

The vehicle may further include a plurality of seat rails disposed on the ramp apparatus and coupled to the ramp apparatus.

On the plurality of seat rails or at the same height as upper surfaces of the seat rails, an interior floor may be set.

The ramp apparatus may include: a housing; a plurality of reinforcing rails coupled to an upper surface of the housing; and a plurality of connecting rails coupled to the upper surface of the housing, on both sides of the reinforcing rails.

The seat rails may be disposed on the upper surface of the housing, in parallel to the reinforcing rails, with the connecting rails interposed therebetween, and may be provided with a connecting bracket on both side surfaces. The connecting bracket may be inserted into the connecting rails and may be bolted to the housing together with the connecting rails.

The vehicle may include a pair of cross members coupled to a lower surface of the floor panel while connecting the pair of side sills. The recess portion may be located between the pair of cross members and have the same depth as a height of the housing of the ramp apparatus. The reinforcing rails may have ends protruding from the housing on both sides of the housing, and the ends on both sides may be coupled to the cross members.

The side sills may include: a side sill inner panel; and a reinforcing side member connected to one side of the side sill inner panel.

The lower arm assembly may be disposed on an upper surface of the side sill inner panel.

The side sills may have a concave portion provided by an upper surface of a longitudinal middle portion of the side sill being formed low. The lower arm assembly may be coupled to a mounting portion provided on the upper surface of the side sill inner panel in a position away from the concave portion.

The door may include: a door panel; an upper arm assembly installed on an upper side of the vehicle and supporting an upper portion of the door panel; and a lower arm assembly coupled to the side sills and supporting a lower portion of the door panel.

The door panel may be capable of contacting the side sills, and a contact point between the side sills and the door panel may be located to be lower than the ramp apparatus or the floor panel.

According to an embodiment of the present disclosure, a door can include: a door panel; an upper arm assembly supporting an upper portion of the door panel; and a lower arm assembly supporting a lower portion of the door panel. The upper arm assembly can include: an upper support rail fixed to the upper portion of the door panel; an upper slider slidably installed on the upper support rail; and a first upper arm and a second upper arm each having one end connected to a vehicle body and the other end connected to the upper slider rotatably.

The upper arm assembly may further include: an upper support coupled to an upper side of the vehicle body and having a first hinge hole to which one end of the first upper arm is rotatably connected, and a second hinge hole to which one end of the second upper arm is rotatably connected; and a drive portion mounted on the upper support, connected to the first upper arm and rotating the first upper arm.

The first upper arm may further include a hub fixed to the one end, and may be rotatably connected to the first hinge hole, via a spool pin inserted into the hub and fixed to the upper support.

An outer peripheral surface of the hub may include a sector gear having a plurality of tooth-shaped portions thereon, and the drive portion may include a motor and a gear. The sector gear may be engaged with the gear, so that the first upper arm can rotate around the spool pin.

The upper slider may have a first hinge portion and a second hinge portion spaced apart from each other by a set, selected, or predetermined distance, the other end of the first upper arm may be rotatably connected to the first hinge portion, and the other end of the second upper arm may be rotatably connected to the second hinge portion.

The upper arm assembly may include an opening wire and a closing wire that apply a driving force so that the upper slider is capable of sliding.

One end of the opening wire and one end of the closing wire may be fixed by being caught on the spool pin, the other end of the opening wire may be fixed to a first fixing protrusion of the upper support rail, relatively adjacent to the second hinge portion, and the other end of the closing wire may be fixed to a second fixing protrusion of the upper support rail, relatively adjacent to the first hinge portion.

The lower arm assembly may include: a lower support mounted on a side sill of the vehicle body and having a plurality of hinge holes; a lower main arm having one end hingedly connected to the lower portion of the door panel; a T-bracket having a column portion and a pair of wing portions formed on one end of the column portion, the other end of the column portion being coupled to the other end of the lower main arm; a first lower sub-arm having one end rotatably connected to the lower support and the other end hingedly connected to one of the pair of wing portions; and a second lower sub-arm having one end rotatably connected to the lower support and the other end hingedly connected to the other of the pair of wing portions.

The lower arm assembly may further include: a lower support rail fixed to the lower portion of the door panel; and a lower slider that is slidably installed on the lower support rail and to which one end of the lower main arm is rotatably connected.

### BRIEF DESCRIPTION OF THE DRAWINGS

The above and other aspects features and advantages of example embodiments of the present disclosure can be more clearly understood from the following detailed description, taken in conjunction with the accompanying drawings, in which:

FIG. 1 is a perspective view illustrating a door and a vehicle body of a vehicle according to an embodiment of the present disclosure;

FIG. 2 is a perspective view illustrating a lower part of the vehicle body in FIG. 1;

FIG. 3 is a side view of FIG. 2;

FIG. 4 is a perspective view of FIG. 2 from which a ramp apparatus and a seat rail are omitted;

FIG. 5 is a cross-sectional view taken along line A-A of FIG. 3, illustrating a closed state of the door according to an embodiment of the present disclosure;

FIG. 6 is a cross-sectional view taken along line B-B of FIG. 3, illustrating a state in which the ramp apparatus is deployed according to an embodiment of the present disclosure;

FIG. 7 is a diagram illustrating an operating state of a ramp apparatus according to an embodiment of the present disclosure;

FIG. 8 is a perspective view illustrating a ramp apparatus and a seat rail according to an embodiment of the present disclosure;

FIG. 9 is a cross-sectional view taken along line C-C of FIG. 2;

FIG. 10 is a perspective view illustrating an upper arm assembly of a door according to an embodiment of the present disclosure;

FIG. 11 is an exploded perspective view of the upper arm assembly illustrated in FIG. 10;

FIG. 12 is a drawing illustrating an arrangement and operation of wires in an upper arm assembly according to an embodiment of the present disclosure;

FIG. 13 is a drawing illustrating an operation of an upper arm assembly according to an embodiment of the present disclosure;

FIG. 14 is a perspective view illustrating a lower arm assembly of a door according to an embodiment of the present disclosure;

FIG. 15 is an exploded perspective view of the lower arm assembly illustrated in FIG. 14; and

FIG. 16 is a drawing illustrating an operation of a lower arm assembly according to an embodiment of the present disclosure.

### DETAILED DESCRIPTION OF ILLUSTRATIVE EMBODIMENTS

Hereinafter, example embodiments of the present disclosure will be described in detail through example drawings. When adding reference numerals to components of respective drawings, same components can be given same numerals as much as possible even if they are illustrated in different drawings.

A vehicle can refer to various vehicle types that can move a transported object such as a person, an animal, or an object from a starting point to a destination. Such vehicles are not necessarily limited to vehicles that run on roads or tracks.

In this specification, for the convenience of explanation, example embodiments of the present disclosure are described using a vehicle having a motor that receives power from a battery, such as a hybrid vehicle or an electric vehicle, as an example, but the present disclosure is not necessarily limited thereto.

In this specification, the terms “first”, “second”, etc. may be used to describe various components, but these components are not necessarily limited in terms of order, size, location, or importance by the terms “first”, “second”, etc., and can be named with such adjectives merely for the purpose of distinguishing one component from another.

In this specification, the terms “on,” “below, “upward”, “downward”, “upper”, “lower”, “left/right”, “inner”, “outer”, “front”, “rear”, “forth”, “back,” etc. can be used in relation to direction with respect to the vehicle or vehicle body.

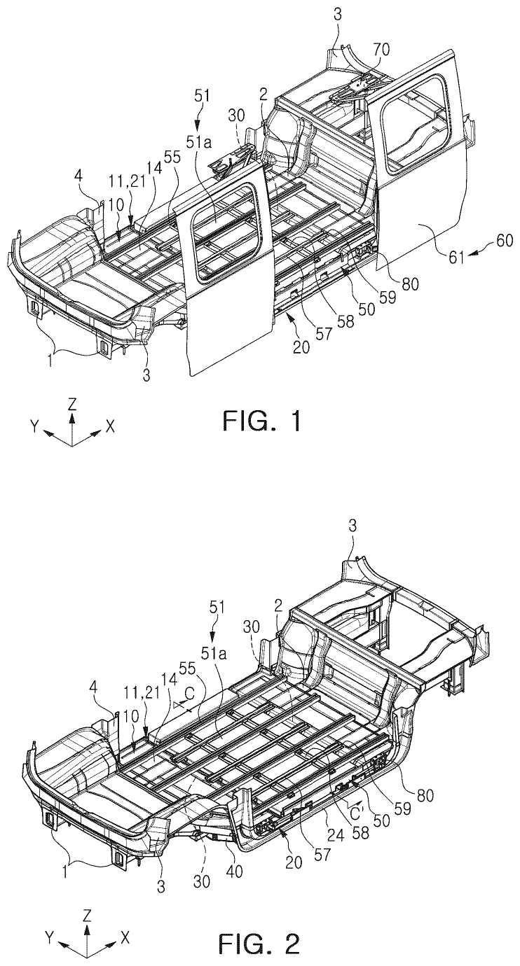

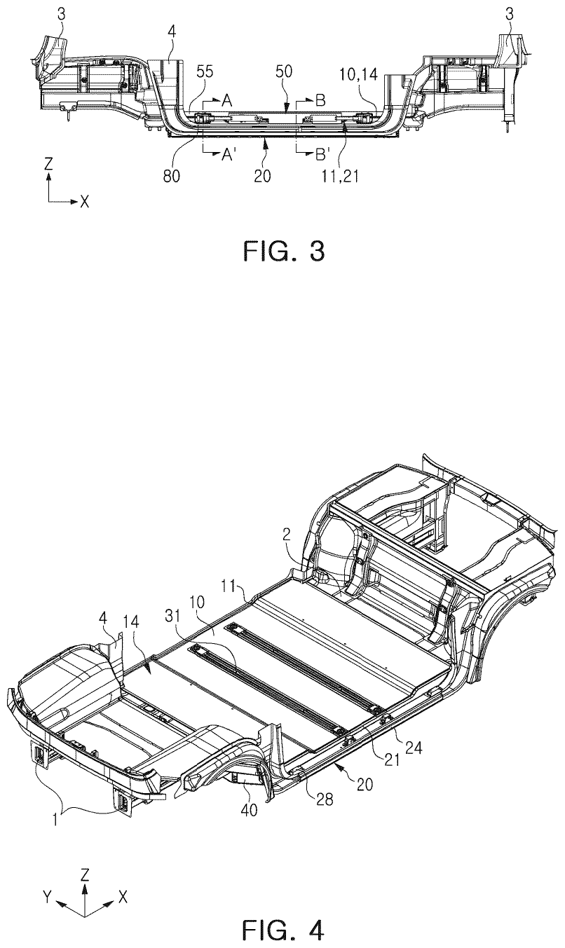

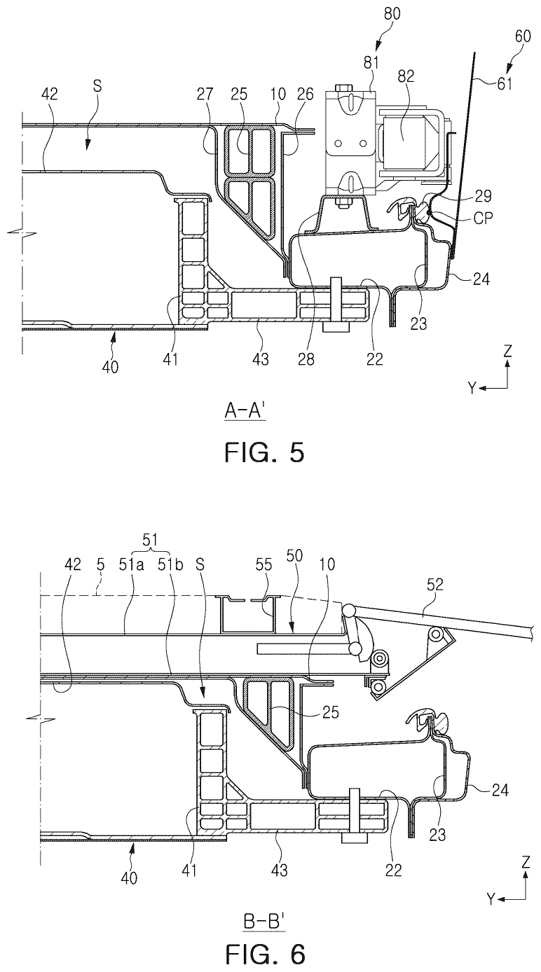

FIG. 1 is a perspective view illustrating a door and a vehicle body according to an embodiment of the present disclosure. FIG. 2 is a perspective view illustrating a lower part of the vehicle body in FIG. 1. FIG. 3 is a side view of FIG. 2. FIG. 4 is a perspective view illustrating FIG. 2 with a ramp apparatus and seat rail omitted. FIG. 5 is a cross-sectional view taken along line A-A of FIG. 3. FIG. 6 is a cross-sectional view taken along line B-B of FIG. 3.

As illustrated in FIGS. 1 to 6, a vehicle according to an embodiment of the present disclosure may include a floor panel 10, a battery module 40, a ramp apparatus 50, and a door 60, any of, any combination of, or all of which may be in plural or may include plural components thereof.

The vehicle may include a vehicle body, and the vehicle body may be manufactured in various shapes and sizes. For example, the vehicle body may be formed in a shape that is approximately rectangular, hexahedron, and symmetrical in the front and rear.

The vehicle body includes pillars 3 installed to extend in the height direction respectively from the four corners (when viewed in a plan view), and side walls or windows may be provided between the pillars 3.

A boarding gate can be formed on at least one of the left and right side surfaces of the vehicle body, and at least one door 60 may be installed on the boarding gate. In FIG. 1, a pair of doors disposed symmetrically in one-side boarding gate is illustrated, but the present disclosure is not necessarily limited thereto.

The skeletal structure of a lower portion of the vehicle body may be composed of a pair of side sills 20 extending in the longitudinal direction (X) of the vehicle and forming a side surface of the vehicle body, and a plurality of cross members 30 extending in the width direction (Y) of the vehicle and coupled to both side sills.

A pair of side sills 20 may be disposed on the left and right sides of the lower portion of the vehicle body, and the pair of side sills may be spaced apart from each other along the width direction (Y) of the vehicle. These side sills 20 may perform a function of protecting the passenger space in the event of a side collision of the vehicle while forming an appearance of the vehicle side.

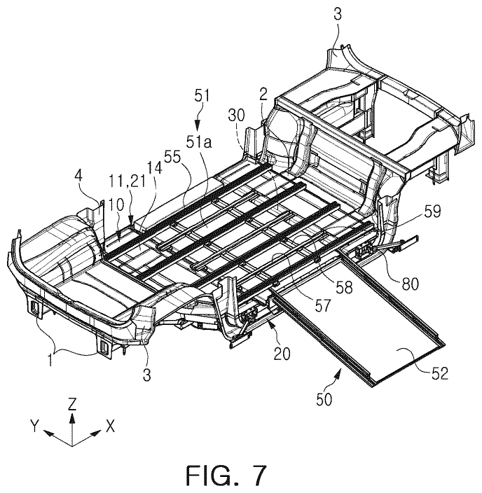

At least one of a pair of side sills 20 may have a concave portion 21 in which an upper surface is formed lower than the surroundings in a longitudinal middle portion of the side sill (for example, in the longitudinal direction (X) of the vehicle). The concave portion may be positioned to correspond to the door 60 of the vehicle. The space created by the concave portion may be used for the platform 52 (see FIG. 7) of the ramp apparatus 50 to enter, exit, and move.

The side sill 20 may include a side sill inner panel 22, a side sill outer reinforcement 23, and a side sill outer panel 24.

The side sill inner panel 22 may be joined to one side of the side sill outer reinforcement 23. The side sill outer reinforcement 23 may be joined to the side sill inner panel 22 to form a closed section. By forming a closed section, the rigidity of the side sill 20 may be reinforced, so that the collision load may be attenuated when the vehicle is lateral-collided.

The side sill outer panel 24 may be joined to the other side of the side sill outer reinforcement 23.

The side sill 20 may be joined as a single piece by welding the side sill inner panel 22, the side sill outer reinforcement 23, and the side sill outer panel 24 in three layers on the lower end portion and/or upper end portion thereof.

The upper end portion or lower end portion of the side sill 20 may be processed by a sealer (not illustrated) in the longitudinal direction (X) of the vehicle to form sealing.

Optionally, referring to FIG. 5, in the upper end portion or lower end portion of the side sill 20, a sealing member 29, called a weather strip, which may block noise, wind, dust, rain, or the like coming in from the outside of the vehicle, may be installed on the outer surface of the side sill outer panel 24. This sealing member may form a contact point (CP) that comes into contact with the door 60.

In a vehicle according to an embodiment of the present disclosure, each side sill 20 may further include a reinforcing side member 25 connected to the side sill inner panel 22, a side sill extension 26 interposed between the side sill inner panel 22 and the reinforcing side member 25, and an inclined panel 27 adjacent the reinforcing side member 25.

The reinforcing side member 25 may be formed by extrusion using, for example, aluminum or an aluminum alloy as a material. The reinforcing side member 25 may have a bulkhead structure inside to have a plurality of closed sections. The plurality of closed sections can supplement the support stiffness of the reinforcing side member itself, and enable the reinforcing side member to directly receive and withstand impact when the vehicle is hit from the side.

The reinforcing side member 25 may be connected to the inner surface of the side sill inner panel 22 in the width direction (Y) of the vehicle, for example, the surface thereof opposite to the side sill outer reinforcement 23, via the side sill extension 26.

This reinforcing side member 25 may reinforce the rigidity of the side sill 20 whose cross-sectional size in the vertical direction (for example, in the height direction (Z) of the vehicle) can be reduced due to the concave portion 21. The reinforcing side member may support the deformation of the side sill inner panel 22 inward in the width direction (Y) of the vehicle when the vehicle is subjected to a side collision, while absorbing the collision load by being deformed together with the side sill inner panel 22.

The reinforcing side member 25 may secure rigidity not only for the impact energy acting in the lateral direction of the side sill 20, but also for the impact energy acting in the longitudinal direction (X) of the vehicle.

By the reinforcing side member 25 configured and disposed in this way, the amount of the side sill 20 introduced inwardly may be minimized in the event of a side collision of the vehicle, so that the vehicle can have an advantage of being able to safely protect passengers.

The reinforcing side member 25 of the side sill 20 may be bolted to the floor panel 10, the ramp apparatus 50, and the like.

To couple the reinforcing side member 25 to the floor panel 10, the ramp apparatus 50, and the like, the reinforcing side member may be provided as a pipe nut (not illustrated). Then, a bolt inserted inside the ramp apparatus 50 may sequentially pass through the lower case 51b (see FIG. 6) of the ramp apparatus, the floor panel, and the like, and be inserted and fastened to the pipe nut.

A tool hole 54 into which a tool may be inserted for tightening the bolt may be formed in the upper surface of an upper case 51a constituting a housing 51 of the ramp apparatus 50.

The side sill extension 26 may be formed of a plate having a cross-sectional shape bent into an inverted L shape. The lower end portion of the side sill extension may be joined to the side sill inner panel 22 by welding such as spot welding.

The reinforcing side member 25 can be formed of an extruded material and can be formed of a different material from that of the side sill inner panel 22 or the side sill extension 26, and thus, they may not be able to be directly connected to each other by joining such as spot welding.

Accordingly, the reinforcing side member 25 may be substantially connected to the side sill inner panel 22 and the side sill 20 by being coupled to the side sill extension 26 by a heteromaterials joining member, such as a flow drill screw (FDS) or the like, for example.

The upper end portion of the side sill extension 26, which can be bent and formed horizontally, may be joined to the lower surface of the floor panel 10 by welding, such as spot welding.

The inclined panel 27 may partially surround the reinforcing side member 25 from the inside in the width direction (Y) of the vehicle while connecting the side sill 20 and the floor panel 10.

The upper end portion of the inclined panel 27 can be formed horizontally by folding and may be joined to the lower surface of the floor panel 10 by welding, such as spot welding, and the lower end portion of the inclined panel can be formed vertically by folding and may be joined to the outer side surface of the side sill inner panel 22 by welding, such as spot welding.

Adhesive can be applied to the outer surface of the inclined surface provided on the reinforcing side member 25, so that the inclined panel 27 and the reinforcing side member 25 may be joined.

The side sill extension 26 and the inclined panel 27 may form an additional side sill located further inwardly in the width direction (Y) of the vehicle than the side sill 20.

Therefore, the side sill 20 may be coupled to the floor panel 10 and installed on the vehicle body via the reinforcing side member 25, the side sill extension 26, and the inclined panel 27.

The floor panel 10 may be disposed between a pair of side sills 20. The floor panel may partition a passenger space where passengers board.

In detail, the floor panel 10 may be joined to the side sills by welding, for example, at least the left and right edges of the floor panel to the side sill extensions 26 of respective side sills 20.

The floor panel 10 may include a recess portion 11 that is concavely formed downwardly. The floor panel 10 having the recess portion 11 may be made of a metal material such as steel, for example, and may be formed by forming using a press, bending, roll forming, combinations thereof, or the like.

The recess portion 11 may have a cross-sectional shape that is approximately U-shaped or an inverted trapezoid. By this recess portion, the floor panel 10 may be formed in two steps along the longitudinal direction (X) of the vehicle. Accordingly, the floor panel 10 may have a bottom surface of the recess portion 11 and upper surfaces 14 other than the recess portion.

The recess portion 11 may have a depth equal to or greater than the depth of the concave portion 21 formed on the side sill 20. The recess portion may have a depth equal to the height of the housing 51 of the ramp apparatus 50.

Accordingly, the ramp apparatus 50 may be stably seated within the recess portion 11, to be not interfered with or hindered during the operation of the ramp apparatus.

Because the ramp apparatus 50 can be positioned within the recess portion 11 and can be disposed lower than before, the inclination of the platform may satisfy the inclination of the regulation without increasing the step height. Accordingly, a vehicle according to an embodiment may maintain and/or improve the convenience of boarding and disembarking of passengers.

The battery module 40 may be disposed in the longitudinal-direction (X) middle portion of and the height-direction(Z) lower portion of the vehicle. A battery space(S) in which the battery module can be mounted may be provided in the vehicle body.

For example, the battery module 40 may include one or more battery cells capable of being charged and discharged, a battery case 41 that accommodates the battery cells, and a cover 42 that covers the upper portion of the battery case. Because the configuration of the battery module can be already widely known, a detailed description of the configuration of the battery module is omitted in this specification, and the battery module is described and illustrated as a single component (for simplifying illustration).

A floor panel 10 may be installed above the battery space(S). In detail, the battery module 40 may be mounted on a pair of side sills 20 to be disposed below the floor panel.

In detail, for example, side flanges 43 may be provided on both sides of the battery case 41, respectively, and each side flange can be coupled to the lower surface of the side sill inner panel 22 of the corresponding side sill 20 through bolting or the like, so that the battery module 40 may be mounted on a pair of side sills.

A plurality of cross members 30 may be coupled to the side surfaces of the side sills 20 (for example, the inclined surface of the inclined panel 27) and the lower surface of the floor panel 10, at intervals from each other along the longitudinal direction (X) of the vehicle. One pair of cross members 30 among the plurality of cross members may be positioned adjacent to the ramp apparatus so that the ramp apparatus 50 may be coupled thereto.

The plurality of cross members 30 may each be formed as a member formed of a single plate having a cross-sectional shape that is bent or curved to have an open cross-section, for example, or a member formed by joining two or more plates in the longitudinal direction thereof, for example, in the width direction (Y) of the vehicle. However, the present disclosure is not necessarily limited thereto, and the cross member may be provided as a member of a tubular shape having a hollow portion therein and a cross-sectional shape of a polygon having four or more corners.

Optionally, first flange surfaces may be formed on both ends of the cross members 30 in the longitudinal direction, for example, on both ends thereof in the width direction (Y) of the vehicle. Each first flange surface may be inclined corresponding to the inclined surface of the inclined panel 27 of the side sill 20. The first flange surface may be joined to the outer surface of the inclined surface of the inclined panel by welding, such as spot welding, laser welding, or arc welding using carbon dioxide or the like.

A second flange surface may be formed on edges extended along the longitudinal direction of the cross members 30 to connect the cross members to the floor panel 10. The second flange surface may be joined to the lower surface of the floor panel by welding, such as spot welding, laser welding, or arc welding using carbon dioxide or the like.

These plurality of cross members 30 may reinforce the rigidity of the vehicle body against the collision load entering in the longitudinal direction of the cross member due to the folded cross-sectional shape of the cross members.

When the side surface of the vehicle collides, the collision load transmitted to the cross member 30 is transmitted to the side sills 20 mechanically coupled to the cross member, and may be distributed in the longitudinal direction (X) of the vehicle along the side sills.

The floor panel 10 may be disposed on the cross members 30 and coupled to respective cross members by welding and/or bolting, or the like. The recess portion 11 may be located between an adjacent pair of cross members.

Optionally, the vehicle may further include at least one reinforcing cross member 31 that is disposed on the floor panel 10, extends in the width direction (Y) of the vehicle, and has both ends coupled to the side sills 20 respectively. By providing the reinforcing cross member in this way, the rigidity of the side sills, whose cross-sectional sizes in the vertical direction can be reduced due to the concave portion 21, may be reinforced.

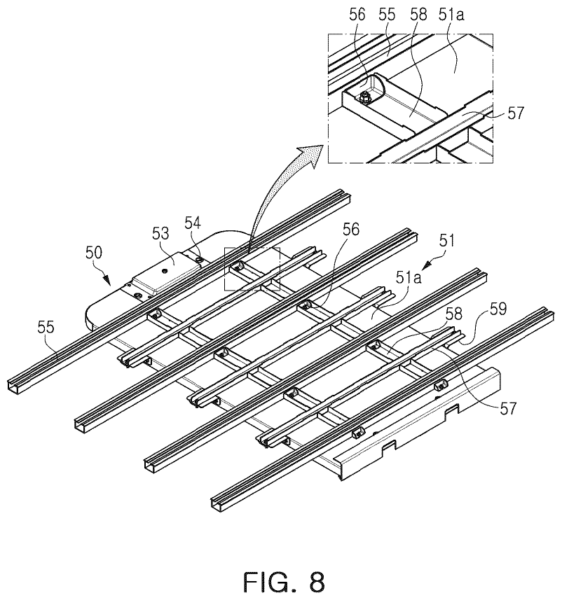

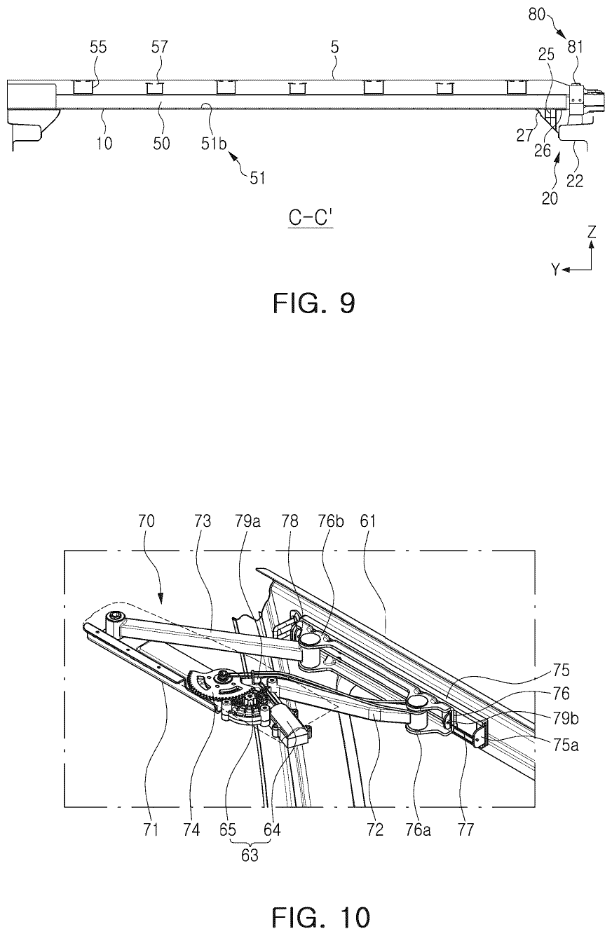

FIG. 7 is an operating status diagram of a ramp apparatus according to an embodiment of the present disclosure. FIG. 8 is a perspective view illustrating a ramp apparatus and a seat rail according to an embodiment of the present disclosure. FIG. 9 is a cross-sectional view taken along line C-C of FIG. 2.

Referring to FIGS. 7 and 8, the ramp apparatus 50 may include a housing 51, a platform 52 that may move between a storage position within the housing and a deployed position outside the housing, and a ramp drive portion 53 that can be installed in the housing and can apply driving force to the platform. The ramp drive portion may include a motor, a reducer, and the like.

The ramp apparatus 50 may further include a power transmission mechanism (not illustrated) that can be interposed between the ramp drive portion 53 and the platform 52 and can transmit the driving force of the ramp drive portion to the platform. As the power transmission mechanism, for example, a mechanism having a pair of sprockets and a chain, or a mechanism having a gear and a lead screw, or the like may be employed, but is not necessarily limited thereto.

The ramp apparatus 50 configured in this manner may be installed in the recess portion 11 of the floor panel 10 and fixedly coupled to the floor panel. When the driving force of the ramp drive portion 53 is transmitted to the platform 52 via the power transmission mechanism, the platform may be withdrawn from the housing 51 and disposed in the deployed position with one end touching the ground. Then, when the ramp drive portion is operated in contrary, the platform may be drawn into the housing and disposed in the storage position.

In this specification, for the convenience of explanation, a more detailed description of the configuration and operation of the ramp apparatus 50 will be omitted. Instead, the description will focus on the coupling relationship between the ramp apparatus and the vehicle body.

The housing 51 may accommodate components of the ramp apparatus, such as the platform 52, the ramp drive portion 53, and the like. The housing 51 may be equipped with an upper case 51a and a lower case 51b (see, e.g., FIG. 6).

The housing 51 may include a plurality of reinforcing rails 57 coupled to the upper surface of the upper case 51a, and a plurality of connecting rails 58 coupled to the upper surface of the upper case on both sides of each reinforcing rail 57.

The reinforcing rail 57 may be formed of a single plate having a cross-sectional shape that is bent or curved to have an open cross-section, for example, but is not necessarily limited thereto. For example, the reinforcing rail may have an open cross-section having a shape of a roughly inverted hat.

The reinforcing rail 57 may have a length longer than the length of the width direction (for example, the longitudinal direction (X) of the vehicle) of the housing 51. Accordingly, the reinforcing rail may extend across the housing, and furthermore, ends of the reinforcing rail may protrude from the housing in the longitudinal direction of the vehicle, on both sides of the housing.

The reinforcing rail 57 may be coupled to the upper surface of the upper case 51a by welding, such as spot welding.

The connecting rail 58 may be formed of a single plate having a cross-sectional shape that is folded or bent to have an open cross-section, for example, but is not necessarily limited thereto. For example, the connecting rail may have an open cross-section having an approximately U-shaped shape.

A plurality of connecting rails 58 may be disposed symmetrically with respect to the corresponding reinforcing rail on both sides of the reinforcing rail 57. A connecting rail corresponding to one reinforcing rail may be spaced apart from a connecting rail corresponding to another reinforcing rail by a set, selected, or predetermined distance. A seat rail 55 may be positioned in the space between these connecting rails.

This connecting rail 58 may first be bolted to the upper surface of the upper case 51a to determine a joining position, and then may be joined to the upper surface of the upper case by welding such as spot welding.

The plurality of reinforcing rails 57 may include at least pairs, for example, at least two reinforcing rails. The drawings illustrate an example in which three reinforcing rails are applied, but the number of reinforcing rails is not necessarily limited thereto. The longitudinal (for example, longitudinal direction (X) of the vehicle) ends of each reinforcing rail may be bolted to the cross member 30.

A mounting bracket 59 having a cross-sectional shape bent in an inverted L shape and having bolt holes formed therein may be welded to both sidewalls of the upper case 51a, respectively. Bolt holes may be formed in the longitudinal (for example, longitudinal direction (X) of the vehicle) ends of the reinforcing rail 57.

These multiple reinforcing rails 57 may connect the load path between the front side member 1 and the rear side member 2 that are disconnected by the recess portion 11 of the floor panel 10 and the ramp apparatus 50, thereby dispersing and transmitting the collision load and reducing the deformation of the vehicle body when the vehicle collides.

Therefore, in the vehicle according to an embodiment, the ramp apparatus 50 may be coupled to the floor panel 10 and connected and fixed to the vehicle body, for example, to a pair of cross members 30, via the reinforcing rail 57 and the mounting bracket 59 fixed to the upper case 51a of the housing 51.

Above the housing 51 of the ramp apparatus 50, for example, on the upper surface of the upper case 51a, a plurality of reinforcing rails 57, and a plurality of seat rails 55 for installing the seat of the vehicle, may be disposed across the housing of the ramp apparatus and extend along the longitudinal direction (X) of the vehicle.

The seat rail 55 may be formed of a single plate having a cross-sectional shape that is curved or bent to have an open cross-section, for example, but is not necessarily limited thereto. The seat rail may have an open cross-section of approximately a U-shape.

The seat rail 55 may have a length longer than the width-direction length (for example, the longitudinal direction (X) of the vehicle) of the housing 51 and may have a length longer than the length of the reinforcing rail.

As a result, the seat rail 55 may extend across the ramp apparatus 50, the plurality of cross members 30, and the floor panel 10.

The seat rail 55 may be bolted to the upper surface of the upper case 51a. To this end, a connecting bracket 56 having a cross-sectional shape bent in an L shape and having bolt holes formed therein may be joined to both side surfaces of the seat rail by welding such as spot welding or the like.

When the ramp apparatus 50 is settled in the recess portion 11 of the floor panel 10, the upper surface of the upper case 51a and the upper surface 14 of the floor panel 10 may be disposed on the same plane at the same height from the ground.

Then, the plurality of seat rails 55 may be respectively positioned in the space between the aforementioned connecting rails 58, on the upper surface of the upper case 51a, or positioned parallel to the reinforcing rail 57 with the connecting rails interposed therebetween. Respective seat rails may be bolted to the upper surface of the upper case via the connecting bracket 56.

The connecting bracket 56 may be inserted into the connecting rail 58, and may be bolted together with the connecting rails to the upper surface of the upper case 51a.

A plurality of seat rails 55 are disposed in a grid shape on the upper surface of the upper case 51a forming the housing 51 of the ramp apparatus 50, along with a plurality of reinforcing rails 57 and a plurality of connecting rails 58. Accordingly, the ramp apparatus may be firmly fixed to the floor panel 10, and the durability and rigidity of the vehicle body, which are disadvantaged due to the downward arrangement of the ramp apparatus, are supplemented, so that the collision load may be distributed when the side surface is collided, and the deformation of the vehicle body may be minimized.

The housing 51 may include at least one channel portion (not illustrated) formed on the lower surface of the lower case 51b and accommodating a reinforcing cross member 31.

Referring to FIG. 9, in a vehicle according to an embodiment, a ramp apparatus 50 can be positioned on a floor panel 10, a plurality of seat rails 55 can be positioned on the ramp apparatus, and an interior floor 5, for example, a carpet surface, can be set on the plurality of seat rails 55 or at the same height as the upper surface of the seat rails.

Referring again to FIG. 1, as described above, a door 60 may be installed on a boarding gate of a vehicle body.

A door 60 according to an embodiment may include a door panel 61, an upper arm assembly 70 coupled to an upper side of a boarding gate in a vehicle body and supporting an upper portion of the door panel so that the door panel may open and close the boarding gate, and a lower arm assembly 80 coupled to a side sill 20 and supporting a lower portion of the door panel so that the door panel may open and close the boarding gate.

The door panel 61 may be disposed to correspond to the boarding gate of the vehicle body and may be movably and rotatably mounted relative to the vehicle body. Thus, the door panel may close or open the boarding gate.

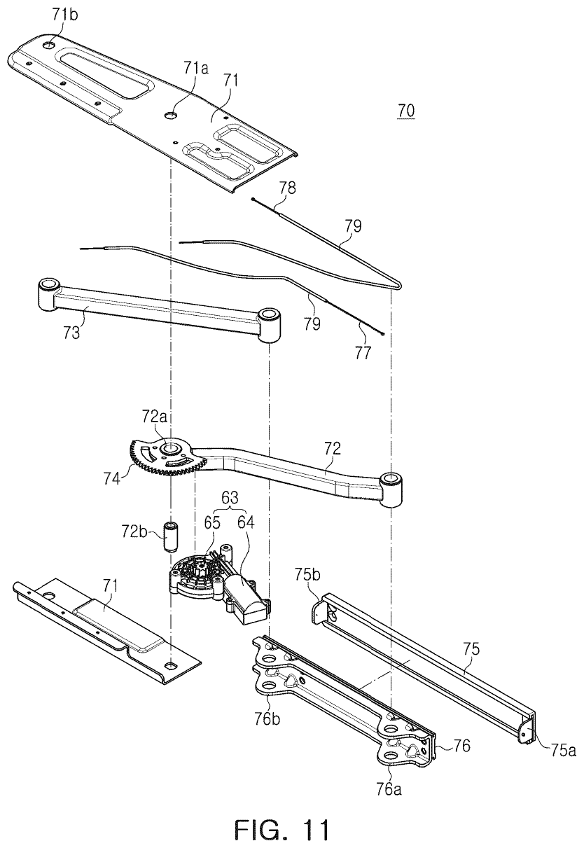

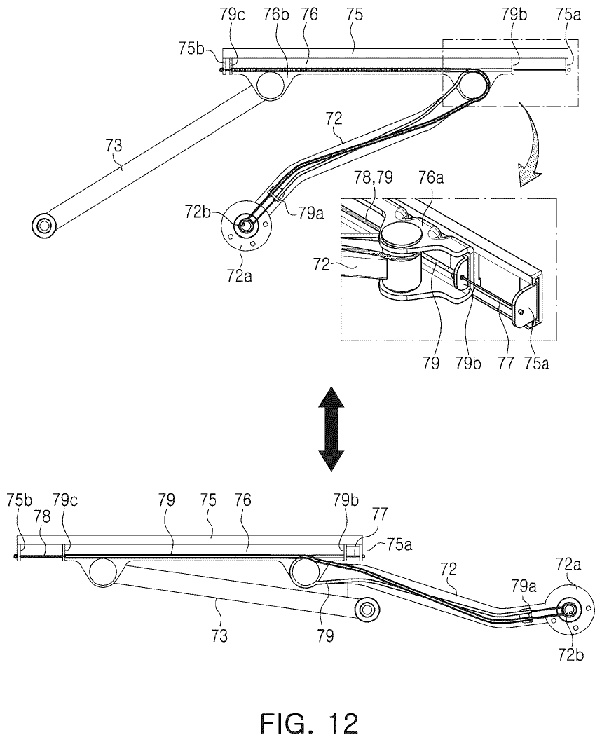

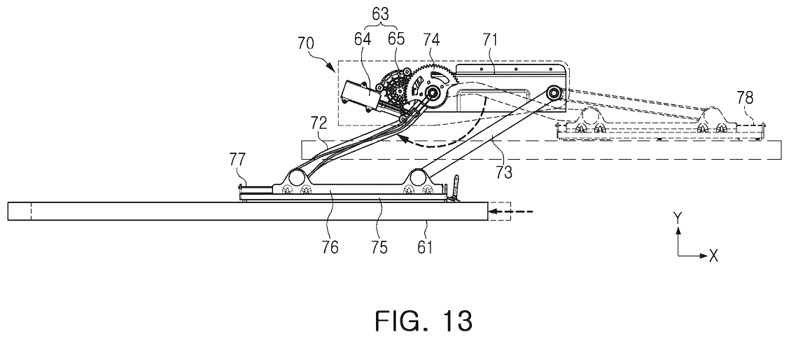

FIG. 10 is a perspective view illustrating an upper arm assembly of a door according to an embodiment of the present disclosure. FIG. 11 is an exploded perspective view of the upper arm assembly illustrated in FIG. 10. FIG. 12 is a drawing illustrating an arrangement and operation of wires in an upper arm assembly according to an embodiment of the present disclosure. FIG. 13 is a drawing illustrating an operation of an upper arm assembly according to an embodiment of the present disclosure.

An upper arm assembly 70 may include an upper support 71, a first upper arm 72, a second upper arm 73, and a door drive portion 63.

The upper support 71 may be formed in the form of a bracket having a plurality of hinge holes 71a and 71b. The drawing illustrates an example in which the upper support is composed of a pair of plates, but is not necessarily limited thereto.

The upper support 71 may be coupled to the upper side of the boarding gate in the vehicle body. In detail, for example, the upper support 71 may be mounted on a roof side (not illustrated) connected along the longitudinal direction (X) of the vehicle above a pair of door support pillars 4 that partition the boarding gate of the vehicle body, but is not necessarily limited thereto.

One end of the first upper arm 72 may have a fixed hub 72a and be rotatably connected to the first hinge hole 71a of the upper support 71 via a spool pin 72b inserted by penetrating through the fixed hub 72a. The other end of the first upper arm may be hinge-connected to the upper portion of the door panel 61. The first upper arm 72 may have a curved shape in the so-called goose neck shape to maximize the opening amount of the door 60. The spool pin 72b may be fixedly coupled to the upper support 71.

One end of the second upper arm 73 may be rotatably hinged to the second hinge hole 71b of the upper support 71, and the other end of the second upper arm 73 may be hinged to the upper portion of the door panel 61. The second upper arm 73 may have a straight linear shape, but is not necessarily limited thereto.

The first upper arm 72 and the second upper arm 73 may be positioned spaced apart from each other by a set, selected, or predetermined distance along the longitudinal direction of the upper support 71, for example, the longitudinal direction (X) of the vehicle. The second upper arm 73 may move dependently according to the rotation and movement of the first upper arm 72, and may share the load of the door panel 61 with the first upper arm 72 to reinforce structural stability.

The door drive portion 63 may include a motor 64, a gear 65, and the like, and may be coupled to the first upper arm 72 to rotate the first upper arm 72. A motor capable of forward and reverse rotation may be employed as the motor 64, and the rotation direction, rotation speed, or the like thereof may be determined according to a control signal from a control unit (not illustrated), for example. The door drive portion 63 may be mounted on the upper support 71.

For example, a sector gear 74 having a plurality of tooth-shaped portions may be formed or integrally combined on one side of the outer peripheral surface of a hub 72a fixed to one end of the first upper arm 72. As the sector gear 74 is engaged with the gear 65 constituting the door drive portion 63, the first upper arm 72 may rotate around the spool pin 72b according to the rotation of the gear 65 and the sector gear 74 by the driving force generated from the motor 64.

Optionally, the upper arm assembly 70 may further include an upper support rail 75 fixed to the upper portion of the door panel 61, and an upper slider 76 slidably installed on the upper support rail 75.

The upper support rail 75 may have an open cross-section shape of a U shape lying approximately sideways. A hollow portion inside the upper support rail 75 may extend along the longitudinal direction of the upper support rail (for example, the longitudinal direction (X) of the vehicle) to form a path for sliding movement of the upper slider 76.

The upper slider 76 may be inserted into the hollow portion of the upper support rail 75 and may slide back and forth along the longitudinal direction of the upper support rail (for example, the longitudinal direction (X) of the vehicle).

The upper slider 76 may include a plurality of hinge portions 76a and 76b spaced apart from each other at a set, selected, or predetermined distance along the longitudinal direction of the upper slider, for example, the longitudinal direction (X) of the vehicle. The other end of the first upper arm 72 may be rotatably hinge-connected to the first hinge portion 76a of the upper slider 76, and the other end of the second upper arm 73 may be rotatably hinge-connected to the second hinge portion 76b of the upper slider 76.

Thereby, the door panel 61 may be rotated together with the first upper arm 72 and the second upper arm 73 by the driving force transmitted to the first upper arm 72, and may be moved relative to the first upper arm 72 and the second upper arm 73, in the longitudinal direction (X) of the vehicle by the upper support rail 75 and the upper slider 76.

The upper arm assembly 70 may include an opening wire 77 and a closing wire 78 that apply driving force so that the upper slider 76 may slide. Fixing protrusions 75a and 75b may be provided on both ends of the upper support rail 75, respectively, in the longitudinal direction of the upper support rail.

One end of the opening wire 77 and one end of the closing wire 78 may be caught and fixed together by a spool pin 72b that is positioned on one end of the first upper arm 72 and fixedly coupled to the upper support 71. This catch and fixation may be obtained by forming an insertion hole in the spool pin and inserting one end of each wire into the insertion hole.

The opening wire 77 and the closing wire 78 may be disposed to be wound in opposite directions about the spool pin 72b. For example, the opening wire 77 may be disposed to be wound counterclockwise about the spool pin 72b, and the closing wire 78 may be disposed to be wound clockwise about the spool pin 72b.

The opening wire 77 may extend from the spool pin 72b along the first upper arm 72, and sequentially pass through the first hinge portion 76a and the second hinge portion 76b of the upper slider 76, and then, the other end thereof may be fixed to the first fixing protrusion 75a of the upper support rail 75 adjacent to the second hinge portion.

The closing wire 78 extends along the first upper arm 72 from the spool pin 72b, and wraps around the hinge pin installed in the first hinge portion 76a of the upper slider 76, and the other end thereof may be fixed to the second fixing protrusion 75b of the upper support rail 75 adjacent to the first hinge portion.

For example, when the door 60 is closed and the motor 64 of the door drive portion 63 rotates to cause the first upper arm 72 to rotate in one direction, the opening wire 77 whose one end is fixed to the spool pin 72b is wrapped around the spool pin according to the rotation of the first upper arm. A tensile force by the opening wire may be applied to the first fixing protrusion 75a of the upper support rail 75 adjacent to the second hinge portion 76b of the upper slider 76 by the amount of the wrapped length.

The closing wire 78 of which one end is fixed to the spool pin 72b is released from the spool pin according to the rotation of the first upper arm 72, and a tensile force by the closing wire is released.

Accordingly, the upper support rail 75 may move relative to the upper slider in the direction from the second hinge portion 76b of the upper slider 76 toward the first hinge portion 76a. As a result, the door panel 61 fixed to the upper support rail 75 may move relative to the first upper arm 72 and the second upper arm 73 in the longitudinal direction (X) of the vehicle, and the opening amount of the door may be increased by the linear movement amount of the door panel.

Conversely, when the door 60 is opened and the motor 64 of the door drive portion 63 rotates in reverse to cause the first upper arm 72 to rotate in the reverse direction, the closing wire 78 whose one end is fixed to the spool pin 72b is wound around the spool pin according to the rotation of the first upper arm. A tensile force by the closing wire may be applied to the second fixing protrusion 75b of the upper support rail 75 adjacent to the first hinge portion 76a of the upper slider 76 by the length of the winding.

The opening wire 77 whose one end is fixed to the spool pin 72b is released from the spool pin according to the rotation of the first upper arm 72, and the tensile force by the opening wire is released.

Accordingly, the upper support rail 75 may move relative to the upper slider in a direction from the first hinge portion 76a of the upper slider 76 toward the second hinge portion 76b. As a result, the door panel 61 fixed to the upper support rail 75 may move relative to the first upper arm 72 and the second upper arm 73 in the longitudinal direction (X) of the vehicle.

Optionally, each of the opening wire 77 and the closing wire 78 may be inserted into and penetrated within the protective tube 79. In detail, the protective tube may partially surround the opening wire or the closing wire.

The protective tube 79 can be a tubular member formed of a flexible material, and may protect each of the opening wire 77 and the closing wire 78, and also guide the movement path of the opening wire and the closing wire. Due to the protective tube, the opening wire and the closing wire cannot deviate far from the original positions thereof and may move relatively within the protective tube.

The protective tube 79 of the opening wire 77 may have one end fixed to a fixing clip 79a installed adjacent to the spool pin 72b in the first upper arm 72, and the other end fixed to a fixing clip 79b installed on an end adjacent to the second hinge portion 76b in the upper slider 76. As a result, both ends of the protective tube of the opening wire may be fixed and the opening wire may be reciprocated relatively within the protective tube.

The protective tube 79 of the closing wire 78 may have one end fixed to a fixing clip 79a installed adjacent to the spool pin 72b in the first upper arm 72, and the other end fixed to a fixing clip 79c installed on an end adjacent to the first hinge portion 76a in the upper slider 76. Thereby, both ends of the protective tube of the closing wire are fixed and the closing wire may be reciprocated relatively within the protective tube.

In this way, the door 60 according to an embodiment can have an advantage of being able to rotate and linearly move the door panel 61 by a single door drive portion 63. Therefore, the door 60 according to an embodiment may swing and slide at the same time, thereby implementing a composite behavior.

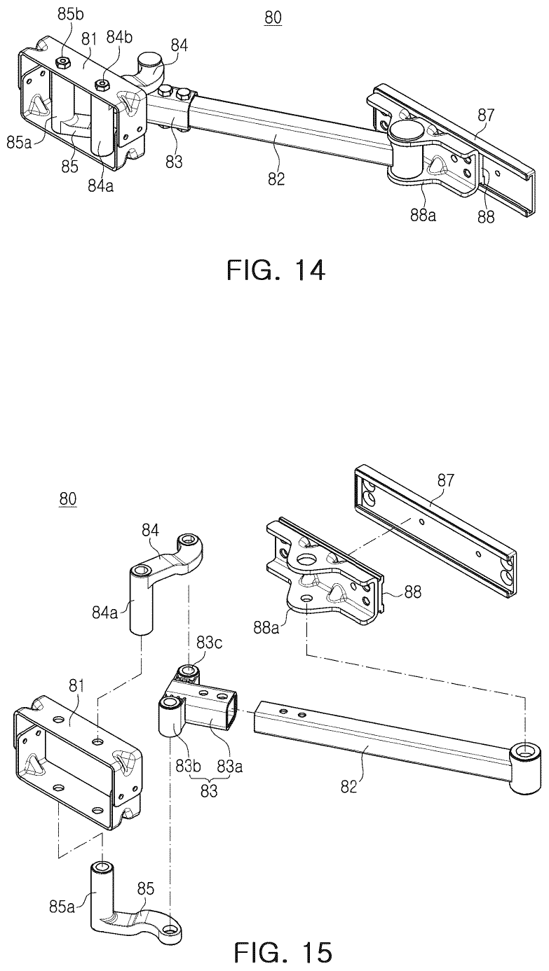

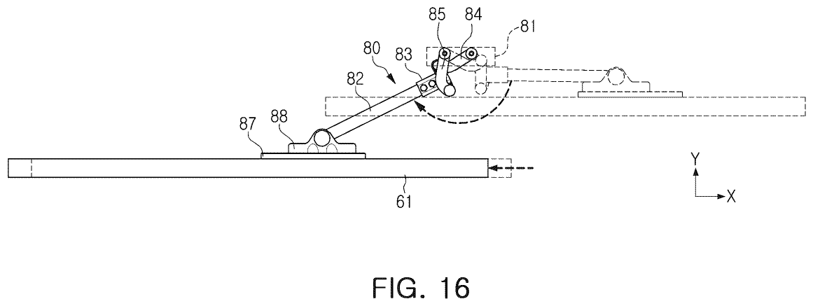

FIG. 14 is a perspective view illustrating a lower arm assembly of a door according to an embodiment of the present disclosure. FIG. 15 is an exploded perspective view of the lower arm assembly illustrated in FIG. 14. FIG. 16 is a drawing illustrating an operation of a lower arm assembly according to an embodiment of the present disclosure.

The lower arm assembly 80 may include a lower support 81, a lower main arm 82, a T-bracket 83, a first lower sub-arm 84, and a second lower sub-arm 85. Thus, the lower arm assembly 80 may include a five-section link mechanism.

The lower support 81 may be formed in the form of a bracket having a plurality of hinge holes 81a and 81b. The drawing illustrates an example in which the lower support is configured to have a quadrangular cross-sectional shape by a pair of plates, for example, an upper plate and a lower plate, bent in a roughly U shape, but the shape of the lower support is not necessarily limited thereto.

The lower support 81 may be coupled to the lower side of a boarding gate in a vehicle body. In detail, for example, the lower support may be mounted on a mounting portion 28 that is welded to an upper surface of a side sill inner panel 22 constituting a side sill 20 of the vehicle body, by bolting or the like. As a result, the lower arm assembly may be coupled to the side sill.

In this way, by positioning and coupling the lower support 81 and the lower arm assembly 80 to the side sill 20, the contact point (CP) between the vehicle body and the door panel 61 may be positioned lower than before. In detail, the contact point (CP) between the side sill and the door panel may be positioned lower than the ramp apparatus 50 or the floor panel 10.

Accordingly, an advantage may be obtained in that the space required for mounting and opening/closing the door 60 may be secured, and at the same time, interference between the deploying platform 52 of the ramp apparatus 50 and the door may be prevented.

The lower support 81 may be positioned in a position that deviates from the concave portion 21 in the longitudinal direction (X) of the vehicle body in the side sill 20. In this way, the lower support 81 and the lower arm assembly 80 are disposed and coupled to be out of the concave portion of the side sill and the recess portion of the floor panel 10, thereby obtaining an advantage in that interference between the deploying platform 52 of the ramp apparatus 50 and the lower arm assembly may be prevented.

One end of the lower main arm 82 may be hinge-connected to the lower portion of the door panel 61. The lower main arm may have a straight linear shape, but is not necessarily limited thereto.

The T-bracket 83 may include one column portion 83a and a pair of wing portions 83b formed by spreading from one end of the column portion. A hinge hole 83c may be formed in the free end of each wing portion. In the T-bracket, the other end of the column portion may be fixedly coupled to the other end of the lower main arm 82. The drawing illustrates an example in which a T-bracket is bolted to the other end of the lower main arm, but the present disclosure is not limited thereto.

The first lower sub-arm 84 and the second lower sub-arm 85 may have shapes that are bent in opposite directions symmetrically to each other. The first lower sub-arm and the second lower sub-arm may be disposed to intersect each other while being spaced apart from each other in the height direction (Z) of the vehicle at the lower support 81.

For example, one end of the first lower sub-arm 84 may have a fixed tubular hinge axis 84a and may be rotatably connected to the lower support 81 via a hinge pin 84b inserted by penetrating through the hinge axis. The other end of the first lower sub-arm may be hinge-connected to a hinge hole 83c of one wing portion 83b on one side of the T-bracket 83.

One end of the second lower sub-arm 85 may have a fixed tubular hinge axis 85a and be rotatably connected to the lower support 81 via a hinge pin 85b inserted by penetrating through the hinge axis. The other end of the second lower sub-arm may be hinge-connected to the hinge hole 83c of the other wing portion 83b on the other side of the T-bracket 83.

If the hinge pins 84b and 85b are configured as bolts, the hinge pin may rotatably connect the lower sub-arms 84 and 85 to the lower support 81 and simultaneously perform the function of coupling the upper plate and the lower plate of the lower support.

Accordingly, in the lower support 81, the first lower sub-arm 84 and the second lower sub-arm 85 may be positioned to be spaced apart from each other by a set, selected, or predetermined distance along the longitudinal direction of the lower support 81, for example, the longitudinal direction (X) of the vehicle, and intersect each other while being spaced apart from each other in the height direction (Z) of the vehicle. The lower sub-arms may move dependently according to the rotation and movement of the lower main arm 82, and may control the trajectory of the door panel 61.

The driving force of the lower main arm 82, the T-bracket 83, the first lower sub-arm 84 and the second lower sub-arm 85 may be generated from the door drive portion 63 and provided to the lower main arm 82 via the door panel 61. According to the rotation of the lower main arm hinged to the door panel, the first lower sub-arm and the second lower sub-arm may be rotated around respective hinge pins 84b and 85b together with the T-bracket.

Optionally, the lower arm assembly 80 may include a sliding mechanism in addition to the five-section link mechanism. To this end, the lower arm assembly may further include a lower support rail 87 fixed to the lower portion of the door panel 61 and a lower slider 88 slidably installed on the lower support rail.

The lower support rail 87 may have an open cross-sectional shape of a U-shape lying approximately sideways. A hollow portion inside the lower support rail may extend along the longitudinal direction of the lower support rail (for example, the longitudinal direction (X) of the vehicle) to form a path for the sliding movement of the lower slider 88.

The lower slider 88 can be inserted into the hollow portion of the lower support rail 87 and may slide back and forth along the longitudinal direction of the lower support rail (for example, the longitudinal direction (X) of the vehicle).

The lower slider 88 can have a hinge portion 88a, and one end of the lower main arm 82 may be rotatably hinged to the hinge portion of the lower slider.

Thereby, the door panel 61 may rotate the lower main arm 82 by the driving force transmitted from the door drive portion 63 and the upper arm assembly 70, and may move relative to the lower main arm in the longitudinal direction (X) of the vehicle by the lower support rail 87 and the lower slider 88.

In this way, the door 60 according to an embodiment can have an advantage of being able to rotate and linearly move the door panel 61 by a single door drive portion 63. Therefore, the door according to an embodiment may implement a composite behavior by being able to swing and slide at the same time, and may obtain the effect of increasing the opening amount of the door by the sliding distance of the door panel 61.

When the door 60 of the vehicle is opened by sliding at the same time as the swing, sufficient space can be created for the platform 52 of the ramp apparatus 50 to be withdrawn from the housing 51, thereby allowing the platform to be disposed in the deploying position without interference with the door panel 61 or the lower arm assembly 80.

As set forth above, according to an embodiment of the present disclosure, a door may be installed without interference with the layout of a battery module and the operation of a ramp apparatus, as well as a vehicle body.

According to an embodiment of the present disclosure, along with a ramp apparatus in which the inclination of the platform can satisfy an inclination of a regulation without increasing a step height, a door can operate in a complex manner to secure an opening amount, thereby maintaining and/or improving a convenience of passengers to get on and off the vehicle.

A number of example embodiments have been disclosed herein. It can be understood that various features of the different example embodiments can be combined for an embodiment of the present disclosure.

While example embodiments have been illustrated and described above, it can be apparent to those skilled in the art that modifications and variations can be made without departing from the scopes of the present disclosure as defined by the appended claims and equivalents thereof.

What is claimed is:

1. A vehicle comprising:
a first side sill;
a second side sill, wherein the second side sill is spaced apart from the first side sill;
a floor panel between and coupled to the first side sill and the second side sill, wherein the floor panel includes a recess portion concaved downwardly;
a battery positioned below the floor panel;
a ramp apparatus located on the recess portion of the floor panel; and
a door supported by a lower arm assembly coupled to the first side sill.

2. The vehicle of claim 1, further comprising seat rails disposed on the ramp apparatus and coupled to the ramp apparatus.

3. The vehicle of claim 2, further comprising an interior floor on the seat rails or at a same height as upper surfaces of the seat rails.

4. The vehicle of claim 2, wherein the ramp apparatus comprises:
a housing;
a plurality of reinforcing rails coupled to an upper surface of the housing; and
a plurality of connecting rails coupled to the upper surface of the housing, on both sides of the reinforcing rails.

5. The vehicle of claim 4, wherein the seat rails are disposed on the upper surface of the housing, in parallel to the reinforcing rails, with the connecting rails interposed therebetween,
wherein the seat rails include a connecting bracket on both side surfaces, and
wherein the connecting brackets are inserted into the connecting rails and are bolted to the housing together with the connecting rails.

6. The vehicle of claim 5, further comprising a pair of cross members coupled to a lower surface of the floor panel while connecting the first side sill and the second side sill,
wherein the recess portion is located between the pair of cross members and has a same depth as a height of the housing of the ramp apparatus, and
wherein the reinforcing rails have ends protruding from the housing on both sides of the housing, and wherein the ends on both sides are coupled to the cross members.

7. The vehicle of claim 1, wherein the first side sill comprises:
a side sill inner panel; and
a reinforcing side member connected to a first side of the side sill inner panel.

8. The vehicle of claim 7, wherein the lower arm assembly is disposed on an upper surface of the side sill inner panel.

9. The vehicle of claim 8, wherein the first side sill includes a concave portion at a longitudinal middle portion of the first side sill, the concave portion being lower than at least some of the floor panel, and
further comprising a mounting portion on and attached to the first-side-sill upper surface of the side sill inner panel in a position away from the concave portion, such that the lower arm assembly is coupled to the mounting portion.

10. The vehicle of claim 1, wherein the door comprises:
a door panel;
an upper arm assembly installed on an upper side of the vehicle and supporting an upper portion of the door panel; and
the lower arm assembly coupled to the first side sill and supporting a lower portion of the door panel.

11. The vehicle of claim 10, wherein the door panel is configured to be capable of contacting the first side sill, such that a contact point between the first side sill and the door panel is located to be lower than the ramp apparatus or the floor panel.

12. A door comprising:
a door panel;
an upper arm assembly coupled to an upper portion of the door panel and configured to support the upper portion of the door panel, wherein the upper arm assembly comprises:
an upper support rail fixed to the upper portion of the door panel,
an upper slider slidably installed on the upper support rail,
a first upper arm, and
a second upper arm, wherein each of the first upper arm and the second upper arm has a first end configured to be connected to a vehicle body and a second end rotatably connected to the upper slider; and
a lower arm assembly coupled to a lower portion of the door panel and configured to support the lower portion of the door panel.

13. The door of claim 12, wherein the upper arm assembly further comprises:
an upper support coupled to an upper side of the vehicle body and having a first hinge hole to which the first end of the first upper arm is rotatably connected, and a second hinge hole to which the first end of the second upper arm is rotatably connected; and
a drive portion mounted on the upper support, connected to the first upper arm and configured to rotate the first upper arm.

14. The door of claim 13, wherein the first upper arm further includes a hub fixed to the first end of the first upper arm, and the hub is rotatably connected to the first hinge hole, via a spool pin inserted into the hub and fixed to the upper support.

15. The door of claim 14, wherein an outer peripheral surface of the hub includes a sector gear having tooth-shaped portions thereon, and
wherein the drive portion includes a motor and a gear,
wherein the sector gear is engaged with the gear, so that the first upper arm is configured rotate around the spool pin.

16. The door of claim 14, wherein the upper slider includes a first hinge portion and a second hinge portion spaced apart from each other by a first distance,
wherein the second end of the first upper arm is rotatably connected to the first hinge portion, and
wherein the second end of the second upper arm is rotatably connected to the second hinge portion.

17. The door of claim 16, wherein the upper arm assembly includes an opening wire and a closing wire that are configured to apply a driving force so that the upper slider is capable of sliding.

18. The door of claim 17, wherein a first-opening-wire end of the opening wire and a first-closing-wire end of the closing wire are configured to be fixed by being caught on the spool pin,
wherein a second-opening-wire end of the opening wire is fixed to a first fixing protrusion of the upper support rail, relatively adjacent to the second hinge portion, and
wherein a second-closing-wire end of the closing wire is fixed to a second fixing protrusion of the upper support rail, relatively adjacent to the first hinge portion.

19. The door of claim 12, wherein the lower arm assembly comprises:
a lower support configured to be mounted on a side sill of the vehicle body and having a plurality of hinge holes;
a lower main arm having a first-lower-main-arm end hingedly connected to the lower portion of the door panel;
a T-bracket having a column portion and a pair of wing portions formed on a first-column-portion end of the column portion, a second-column-portion end of the column portion being coupled to a second-lower-main-arm end of the lower main arm;
a first lower sub-arm having a first first-lower-sub-arm end rotatably connected to the lower support and a second first-lower-sub-arm end hingedly connected to one of the pair of wing portions; and
a second lower sub-arm having a first second-lower-sub-arm end rotatably connected to the lower support and a second second-lower-sub-arm end hingedly connected to another of the pair of wing portions.

20. The door of claim 19, wherein the lower arm assembly further comprises:
a lower support rail fixed to the lower portion of the door panel; and
a lower slider slidably installed on the lower support rail and to which the first-lower-main-arm end of the lower main arm is rotatably connected.
